(19) United States
(12) Patent Application Publication
(10) Pub. No.: US 2012/0266523 A1
(43) Pub. Date: Oct. 25, 2012

(54) Fly killing device

(76) Inventor: Phillip Graham Kirschbaum, Petaluma, CA (US)

(21) Appl. No.: 13/066,558

(22) Filed: Apr. 19, 2011

(51) Int. Cl. A01M 3/02; A01M 3/00

(52) U.S. Cl. 43/135

(57) ABSTRACT

A fly killing device with a flat disk shaped member, an outer rigid tube, an inner rigid tube, an elastic cord and a pull knob. The inner rigid tube is slidably and telecopically engaged within the outer rigid tube. The elastic cord is slidably and telescopicically engaged within the rigid inner tube member. The elastic cord is attached at one end to the flat disk shaped member and at the opposite end to the pull knob. When a user pulls back on the pull knob, the elastic cord is stretched and, when the pull knob is released by the user, the elastic cord retracts rapidly causing the inner rigid tube and the disk member to shoot forward rapidly for the purpose of killing a small insect such as a fly or mosquito.

### CROSS REFERENCE TO RELATED APPLICATIONS

### Not Applicable

### STATEMENT REGARDING FEDERALLY SPONSORED RESEARCH OR DEVELOPMENT

### Not Applicable

### DESCRIPTION OF ATTACHED APPENDIX

### Not Applicable

### BACKGROUND OF THE INVENTION

This invention relates generally to the field of fly swatters and more specifically to a rapidly firing disk shaped flying insect killing device.

Fly swatters of various shapes and sizes have been used for hundreds of years by people to kill annoying and potentially harmful small flying insects such as flies or mosquitoes. They usually consist of an elongate member terminating in a flat, semi-rigid sheet like member. The user holds one end of the elongate member at one end and, with a rotating wrist snap, causes the sheet-like member to rapidly move towards the insect and hopefully kill it before it has a chance to fly away.
M Martin Belokin, in his U.S. Pat. No. 4,386,478, now in the public domain, describes an insect killing gun that uses a spring biased disk shaped member to cause the disk to fly towards a fly or mosquito at rest on a wall.
However, there a some deficiencies in the prior technology. First, the gun type device requires that the user aim carefully and hope that the disk will fly in a straight line toward the fly or mosquito to be killed. Second, the retrieval of the disk and the resetting of the disk onto the gun shape is time consuming. This can potentially give enough time for the flying insect to fly out of the area. Finally, the gun type device is relatively expensive to manufacture in relationship to other simpler fly swatter designs.

### BRIEF SUMMARY OF THE INVENTION

The primary object of the invention is to provide an telescoping rigid tube and elastic cord device that causes a flat disc shaped member to accurately shoot towards a fly in rapid manner so that the flat portion of the disk lands on the body of a flying insect for the purpose of killing the flying insect.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed fly killing device comprising: a flat disk shaped member, an outer rigid tube, an inner rigid tube, an elastic cord, a pull knob, said inner rigid tube slidably and telecopically engaged within said outer rigid tube, said elastic cord slidably and telescopicically engaged within said rigid inner tube member, said elastic cord centrally attached at one end to said flat disk shaped member, said elastic cord attached at the opposite end to said pull knob, so that when a user pulls back on said pull knob, said elastic cord is stretched and, and when said pull knob is released by said user said elastic cord retracts rapidly causing said inner rigid tube and said disk member to shoot forward rapidly for the purpose of killing a small insect such as a fly or mosquito.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention in the ready to use position.

FIG. 2 is a perspective view of the invention just after the device has been used.

FIG. 3 is a partial side section view of the invention in the ready to use position.

FIG. 4 is a partial side section view of the invention just after use.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

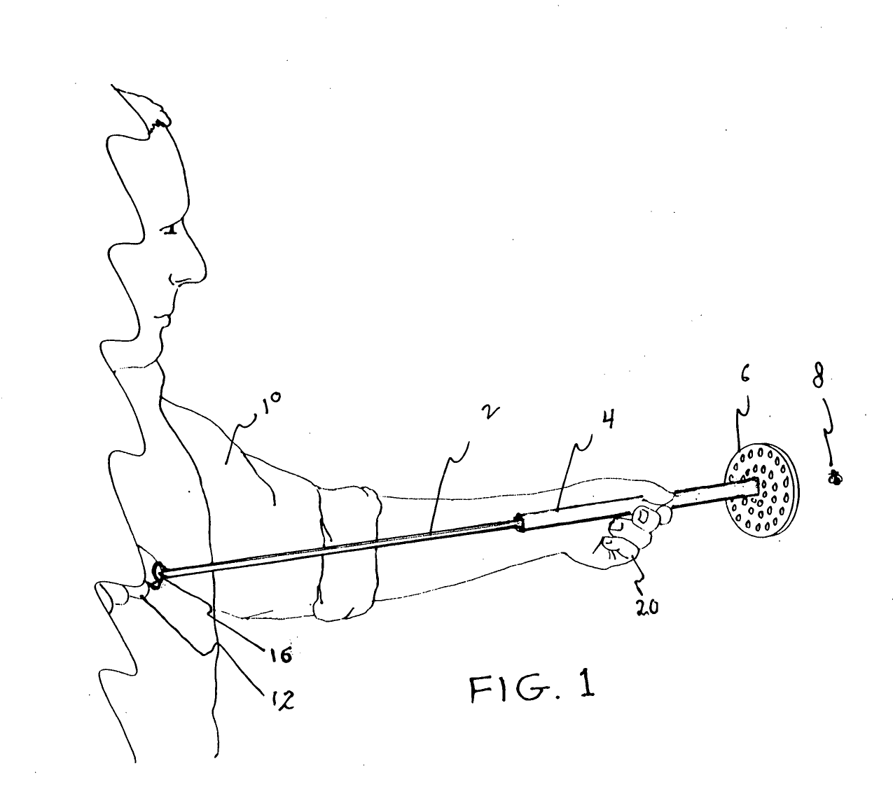

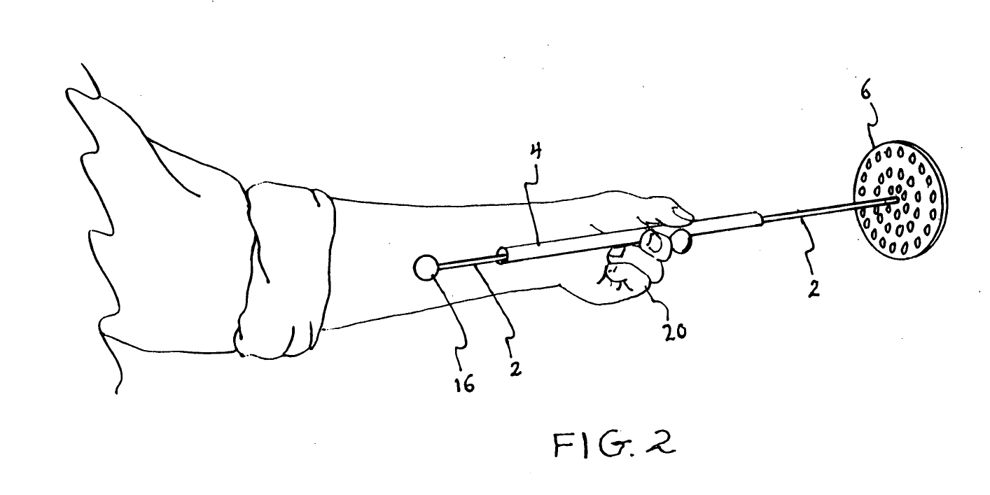

Referring now to FIG. 1 we see a perspective view of the invention in the ready to use mode. The user 10 is pulling back on knob 16 with hand 12. The knob 16 is fixedly attached to inner rigid tube 2. The rigid inner tube 2 is telescopically and slidably retained within a rigid outer tube 4 which the user is holding with his other hand 20. An elastic cord 14, not showing in this view, is located within the inner tube. One end of the cord 14 is fixedly attached to the pull knob 16. The opposite end of the cord 14 is centrally attached to a flat disk shaped member 6. The user 10 has aimed the invention so that the disk 6 is in line with a fly 8 resting on a wall surface. By pulling back on knob 16, the user 10 has caused the elastic cord 14 to stretch. When the user lets go of the knob 16, the inner tube 2 is caused to shoot forward, carrying the flat disk 6 with it. The disk shoots forward with much accuracy since the inner tube 2 is being held at all times in a true trajectory by outer tube 4 as shown in the perspective view in FIG. 2. Additionally, because the only method of attachment of the disk member 6 to the end of elastic cord 14, the disk member 6 can be shot at an angle relative to a wall and the disk member 6 will automatically flex to assume the same angle as it hits the wall, thereby increasing the chances of killing an insect residing on the wall. This is an important distinguishing feature when comparing the present invention to that of M Belokin's fly killing invention shown in U.S. Pat. No. 4,386,478. Mr. Belokin's disk can not flex and therefore must be aimed at an angle that is perfectly perpendicular to the wall for best results. The inner tube 2 is approximately twenty-nine inches long. The outer tube 4 is approximately seventeen inches long. This allows the user to pull the inner tube 2 back approximately fourteen inches while four inches of the inner tube 2 still remains inside outer tube 4 thereby retaining its slidable telescoping nature.

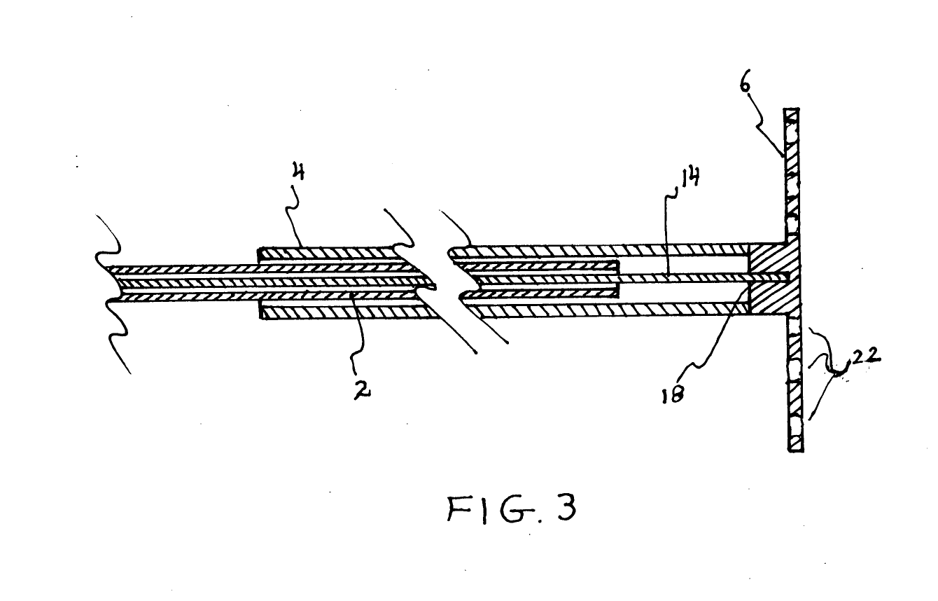

FIG. 3 shows a partial side section view of the invention which longitudinally bisects the inner tube 2, the outer tube 4 and the elastic cord 14 while in the ready to use position. Cord 14 is fixedly attached to disk 6 at central location 18. This view shows the inner tube 2 drawn back so that the shoulder of the disk shape is intimately engaged with the end surface of outer tube 4. Elastic cord 14 is approximately one eighth of an inch thick and has the force to rapidly propel the disk forward when knob 16 is released. Apertures 22 reduce air resistance when the disk is traveling forward.

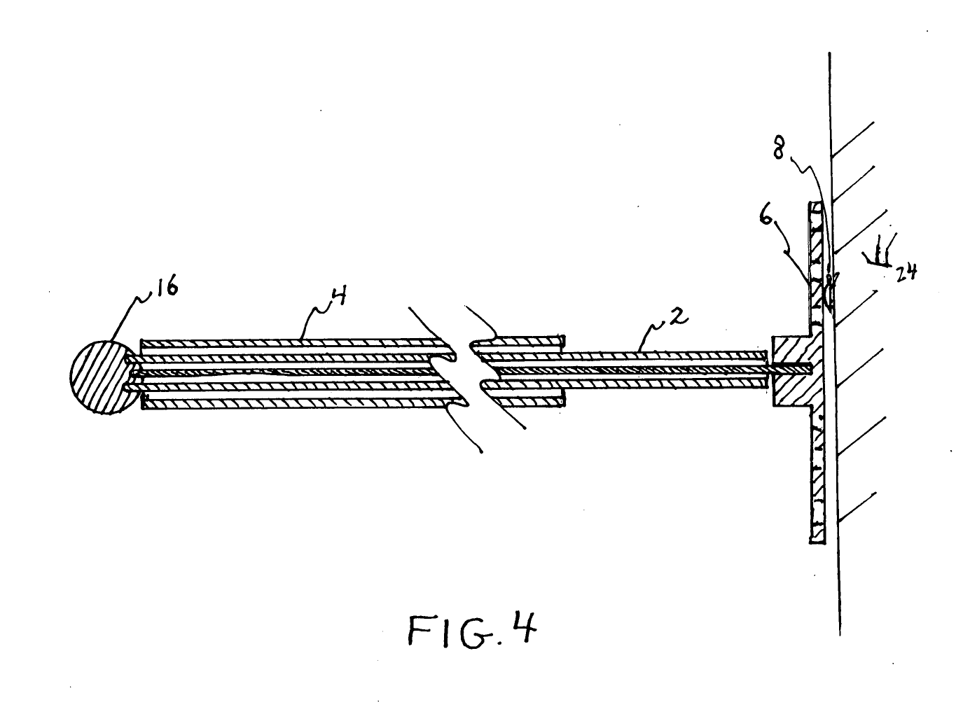

FIG. 4 shows a partial side section view of the invention which longitudinally bisects the inner tube 2, outer tube 4, and elastic cord 14 while in the just after use position. The disk 6 has been propelled forward so that the flat surface of the disk 6 has squashed the fly 8 who was residing on a wall 24. The knob 16 is larger than the outer diameter of the outer tube 4 so that it can not accidentally slip out of outer tube 4 during use.

The entire assembly of the present invention is very simple and relatively inexpensive to manufacture thereby allowing is to sell at a competitive price in relation to other more standard fly swatters on the market today.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Fly killing device comprising:
a flat disk shaped member;
an outer rigid tube;
an inner rigid tube;
an elastic cord;
a pull knob;
said inner rigid tube slidably and telecopically engaged within said outer rigid tube;
said elastic cord slidably and telescopicically engaged within said rigid inner tube member;
said elastic cord attached at on end to said flat disk shaped member;
said elastic cord attached at the opposite end to said pull knob;
so that when a user pulls back on said pull knob, said elastic cord is stretched and; and
when said pull knob is released by said user said elastic cord retracts rapidly causing said inner rigid tube and said disk member to shoot forward rapidly for the purpose of killing a small insect such as a fly or mosquito.

2. A fly killing device as claimed in claim 1 wherein said disk shaped member is semi-rigid and includes a plurality of small apertures to help reduce wind resistance so that said disk can travel at a fast rate of speed.

3. A fly killing device as claimed in claim 1 wherein said disk shaped member is approximately four inches in diameter and one sixteenth of an inch thick.

4. A fly killing device as claimed in claim 1 wherein said outer rigid tube is approximately seventeen inches long and said inner rigid tube member is approximately thirty inches long.

5. A fly killing device as claimed in claim 1 wherein said elastic cord is approximately one eighth of an inch in diameter and in a slightly tensioned condition when at rest within said inner rigid tube.

6. A fly killing device as claimed in claim 1 wherein said disk shaped member is capable of flexing upon impact to a wall to cause said disk shaped member to make full intimate contact with said wall and to increase the chances of killing an insect residing on said wall.
